(19) United States
(12) Patent Application Publication
(10) Pub. No.: US 2003/0181200 A1
(43) Pub. Date: Sep. 25, 2003

(54) Mobile terminal with built in camera and network printing system

(75) Inventor: Takayuki Iida, Kaisei-machi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/391,597

(22) Filed: Mar. 20, 2003

(30) Foreign Application Priority Data
Mar. 20, 2002 (JP) 079345/2002

(51) Int. Cl. H04M 3/00

(52) U.S. Cl. 455/414.1; 455/418

(57) ABSTRACT

Image data obtained by a mobile terminal with a built in camera are efficiently sent to a network printing system run by a DPE store. A cellular phone with a built in camera has communication means for communication via a wireless LAN. The DPE store installs wireless LAN communication equipment for communication via the wireless LAN at railroad stations, bus stops, and in downtown, for example. When a user having the cellular phone obtains the image data by photography and enters a communicable range of the wireless LAN communication equipment, the image data are sent to the wireless LAN communication equipment and stored in an image server of the DPE store. A mini-laboratory generates a print based on the image data.

### BACKGROUND OF THE INVENTION

1. Field of the Invention

The present invention relates to a mobile terminal with a built in camera that can obtain image data by photography and can send the image data to an image server or the like. The present invention also relates to a network printing system that can print the image data sent from the mobile terminal with a built in camera via a network.

2. Description of the Related Art

Recently, a digital camera has been proposed that has a communication function for sending and receiving image data obtained by photography. Cellular phones with built-in cameras that have photography means for obtaining image data by photography (see Japanese Unexamined Patent Publication Nos. 6(1994)-233020, and 2000-253290, for example) are also spreading. In such a digital camera, or a cellular phone with a built-in camera (hereinafter referred to as a mobile terminal with built in camera), image data obtained by photography are temporarily stored in an internal memory. The image data can be displayed on a monitor thereof, or sent by being attached to an E-mail message. Furthermore, the image data can be sent to an image server that manages and stores the image data. The image data stored in the image server can be viewed by an access to the image server from a personal computer or the like, and can be used for generating an electronic photograph album. Moreover, desired image processing can be carried out on the image data, and a printing order regarding the image data can be placed with a laboratory that is connected to the image server.

Following Sophistication of cameras for such mobile terminals, the number of pixels of a photographed image has increased, as has the size of the image data. However, a communication charge for such a mobile terminal is calculated according to a packet-based charge system that becomes expensive in accordance with the amount of data, or according to a time-based charge system that becomes expensive in accordance with communication time. Therefore, the larger the image data become, the higher the communication charge becomes. For example, in the case of packet-based charge system, an average size of image data that are necessary for generating an L-size print is approximately 600 KB when compressed in a JPEG format. If the communication charge is 0.2 yen per 128 bytes, the charge necessary for sending the image data will be as high as 937 yen.

In addition, the communication speed of such a mobile terminal with built in camera is not high. For example, the communication speed varies in the range of 9600 bps for a low communication speed cellular phone and 64000 bps at most for a PHS (personal Handyphone System) . Therefore, the time necessary for sending approximately 600 KB of image data falls between 500 to 75 seconds. In the case of time-based charge system, the communication charge becomes as high as 125 yen for the former case and 20 yen for the latter case, although the charge is lower than in the case of packet-based charge system.

### SUMMARY OF THE INVENTION

The present invention has been conceived based on consideration of the above circumstances. An object of the present invention is therefore to efficiently send image data obtained by a mobile terminal with built in camera.

A mobile terminal with built in camera of the present invention comprises:

photography means for obtaining image data by photography;

first communication means for carrying out data communication via a cellular phone communication network;

second communication means for carrying out data communication with wireless LAN communication equipment via a wireless LAN;

authentication information storing means for storing authentication information that is necessary for carrying out the data communication with the wireless LAN communication equipment via the wireless LAN;

image storing means for storing the image data obtained by the photography means; and

control means for judging whether or not the second communication means is within a communicable range of the wireless LAN communication equipment, for sending to the wireless LAN communication equipment the authentication information stored in the authentication information storing means by carrying out the data communication with the wireless LAN communication equipment in the case where the second communication means has been judged to be within the communicable range, and for controlling the second communication means so that the image data stored in the image storing means are sent to the wireless LAN communication equipment when authentication according to the authentication information is successfully carried out by the wireless LAN communication equipment.

The first communication means carries out the data communication via the cellular phone communication network. The data communication via the cellular phone communication network is assumed to have a data transfer speed of 9600˜64000 bps. The data communication is also assumed to cost 15˜25 yen per minute in the case of a time-based charge system and 0.2 yen per 128 bytes in the case of a packet-based charge system.

The second communication means is used for the data communication via the wireless LAN. The data communication speed is assumed to be 8˜11 MB or more, and a charge therefor is assumed to be fixed.

The wireless LAN communication equipment adopts a specification that has been standardized by the IEEE (Institute of Electrical and Electronic Engineers), for example. More specifically, the wireless LAN communication equipment preferably adopts the IEEE 802.11b specification. The IEEE 802.11b specification is a mainstream standard that uses a frequency band of 2.4 GHz and has a maximum transfer speed of 11 Mbps.

It is preferable for the wireless LAN communication equipment to be installed in a busy place which residents therein often visit (such as a railroad station, a bus stop, a municipal office, a bank, a convenience store, and a downtown center) or an Internet cafe or the like, in an area wherein a DPE store that operates a network printing system can provide a printing service. It is preferable for the mobile terminal with built in camera to be able to communicate on the move, by using a roaming function.

As the authentication information, ESS-ID can be used. ESS-ID is the ID adopted by the international wireless LAN specification IEEE 802.11b, and necessary for establishing a connection to a fixed receiver. The same ESS-ID is used for the mobile terminal with built in camera and for the wireless LAN communication equipment. ESS-ID is case-sensitive, and comprises up-to-32 characters. More specifically, a MAC (Media Access Control) address can be used as the ESS-ID.

It is preferable for the data communication with the wireless LAN communication equipment to adopt WEP (Wired Equivalent Privacy). WEP has a function of improving security by setting an encryption key to wireless packets. In the case where WEP is enabled, communication can be established only in the case where a WEP key set for the mobile terminal with built in camera agrees with a WEP key set for the wireless LAN communication equipment.

In the mobile terminal with built in camera of the present invention, the image storing means may be detached freely therefrom and the second communication means may be installed in the detachable image storing means.

In this case, a removable recording medium such as a memory card is used as the image storing means.

In the mobile terminal with built in camera of the present invention, the control means may generate order information representing the content of an order regarding the image data and control the second communication means so that the order information is sent to the wireless LAN communication equipment at the time of transfer of the image data.

The order information describes the content of the order regarding the image data, and instructs printing of the image data, storing the image data in an image server, and recording of the image data in a recording medium such as a CD-R or a DVD-R, for example. In the case of printing, the order information also describes a print size, a quantity, and the type of printing (such as ordinary printing or postcard printing).

A first network printing system of the present invention comprises at least one laboratory system that has a network for connecting:

at least one piece of the wireless LAN communication equipment that carries out the data communication with the mobile terminal with built in camera of the present invention via the wireless LAN;

an image server that stores the image data received by the wireless LAN communication equipment; and

a mini-laboratory that generates printed matter based on the image data stored in the image server.

The printed matter refers to not only a print, a photograph album, and a postcard generated from the image data but also a T-shirt with the image data printed thereon and a recording medium such as a CD-R having the image data recorded therein.

A second network printing system of the present invention comprises laboratory systems having a network that connects:

at least one piece of the wireless LAN communication equipment that carries out the data communication with the mobile terminal with built in camera of the present invention via the wireless LAN;

an image server that stores the image data received by the wireless LAN communication equipment; and

a mini-laboratory that generates printed matter based on the image data stored in the image server. In the second network printing system of the present invention, each of the laboratory systems judges whether or not the order described by the order information sent from the mobile terminal with built in camera can be dealt with by the mini-laboratory therein, and generates the printed matter in the mini-laboratory according to the image data in the case where the order can be dealt with. The second network printing system of the present invention further comprises transfer means for transferring the image data and the order information to another one of the laboratory systems that can deal with the order in the case where the order cannot be dealt with.

In addition to the laboratory system or systems, the first and second network printing systems of the present invention may further comprise at least one cellular phone communication system having:

data communication equipment connected to the laboratory system or systems via the network and for communicating with the first communication means of the mobile terminal with built in camera of the present invention;

communication control means for judging a communication load on the cellular phone communication network and for obtaining the image data by communicating with the mobile terminal with built in camera in the case where the communication load is comparatively light; and

a temporary storage server for temporarily storing the image data obtained by the communication control means and for sending the image data to the image server of the laboratory system or one of the laboratory systems.

A third network printing system of the present invention comprises at least one laboratory system having a network that connects:

at least one piece of wireless LAN communication equipment for carrying out data communication via a wireless LAN;

an image server for storing image data received by the wireless LAN communication equipment;

a mini-laboratory for generating printed matter based on the image data stored in the image server; and

at least one reading transmission means for reading the image data from a mobile terminal with built in camera comprising photography means for obtaining the image data by photography, and for sending the image data to the wireless LAN communication equipment by carrying out the data communication with the wireless LAN communication equipment via the wireless LAN.

The reading transmission means can be any means that can read the image data through connection with the mobile terminal with built in camera and can send the image data to the wireless LAN communication equipment via the wireless LAN. More specifically, the reading transmission means may be a data reading cable or the like that comprises communication equipment for communication via the wireless LAN. The reading transmission means is preferably a cradle used for recharging the mobile terminal with built in camera. In this case, the cradle has a function of reading the image data from the mobile terminal with built in camera and a function of sending the image data via the wireless LAN.

In addition to the laboratory system or systems, the third network printing system of the present invention may further comprise at least one cellular phone communication system having:

data communication equipment connected to the laboratory system or systems via the network and for communicating with the mobile terminal with built in camera;

communication control means for judging a communication load on a cellular phone communication network and for obtaining the image data by communicating with the mobile terminal with built in camera via the cellular phone communication network in the case where the communication load is comparatively light; and

a temporary storage server for temporarily storing the image data obtained by the communication control means and for sending the image data to the image server of the laboratory system or one of the laboratory systems.

In addition to the laboratory system or systems, the first through third network printing systems of the present invention may further comprise at least one remote area communication system having:

remote area wireless LAN communication equipment installed in a location remote from the laboratory system or systems; and

a remote area image server for temporarily storing image data received by the remote area wireless LAN communication equipment and for sending the image data to the image server in the laboratory system or one of the laboratory systems.

The location remote from the laboratory system or systems refers to a location away from an area wherein a DPE store that operates any one of the network printing systems of the present invention can provide a printing service. For example, in the case where the DPE store is located in Odawara, the remote location refers to a theme park such as Tokyo Disneyland or Universal Studios Japan that is not located in Odawara, for example. The remote location can be a sightseeing spot, downtown in a neighboring city, an airport, a railroad station, or a rest area on a highway, in addition to theme parks.

According to the present invention, the image data obtained by photography with the photography means of the mobile terminal with built in camera are stored in the image storing means. Whether or not the second communication means is within the communicable range of the wireless LAN communication equipment is then judged. In the case where a user of the mobile terminal moves to the communicable range and the second communication means is judged to be within the communicable range, the authentication information stored in the authentication information storing means is sent to the wireless LAN communication equipment, and the wireless LAN communication equipment authenticates the user. The image data stored in the image storing means are then sent to the wireless LAN communication equipment.

The wireless LAN communication equipment receives the image data, and the image data are stored in the image server connected with the wireless LAN communication equipment. The image data are then sent to the corresponding mini-laboratory whereat the printed matter is generated based on the image data.

As has been described above, according to the present invention, the image data are sent to the wireless LAN communication equipment via the wireless LAN that has a much faster communication speed than the cellular phone communication network. For example, if the speed of the wireless LAN is 11 Mbps, the time necessary for sending 600-KB image data is only 0.4 second. Therefore, the user of the mobile terminal with built in camera can efficiently send the image data from the mobile terminal to any one of the network printing systems of the present invention, for requesting storage of the image data in the image server or for requesting generation of the printed matter based on the image data. In the case of wireless LAN, a charge therefor is often fixed. Consequently, the user of the mobile terminal can send the image data in a large amount to the network printing system by paying only the fixed charge.

For the DPE store that operates any one of the network printing systems, the image data can be gathered efficiently without using the cellular phone communication network, which leads to a sales increase.

Furthermore, since the image data are sent if the user of the mobile terminal comes in the communicable range of the wireless LAN communication equipment, the user does not need to operate the mobile terminal for image data transfer. In this manner, the user can be less burdened at the time of image data transfer.

Meanwhile, in the case where the image storing means can be freely detached from the mobile terminal with built in camera, the second communication means may be installed in the image storing means. The DPE store can provide the user of the mobile terminal with built in camera with the image storing means having the second communication means that is installed therein and is communicable only with the wireless LAN communication equipment in the network printing system of the DPE store. Consequently, the image data obtained by the user are sent only to the network printing system of the DPE store. In this manner, the DPE store can easily count the user as a customer thereof, and sales of the DPE store thus increases.

If the order information representing the content of the order regarding the image data is sent at the time of image data transfer, the user can easily request generation of the printed matter and storage of the image data in the network printing system.

In the case where the laboratory systems are used, if the order represented by the order information sent from the mobile terminal with built in camera cannot be dealt with by the mini-laboratory in one of the laboratory systems that receives the order information, the order information and the image data are transferred to another one of the laboratory systems that can deal with the order. In this manner, the case can be prevented from occurring wherein the order cannot be dealt with regardless of reception of the image data.

By using the reading transmission means in the laboratory system or systems, the image data obtained by photography can be sent to the third network printing system even if the mobile terminal with built in camera does not have communication means for communicating with the wireless LAN communication equipment.

In the case where the reading transmission means has the function of recharging the mobile terminal with built in camera, the image data can be sent while the mobile terminal is being recharged. Since recharging is necessary for the mobile terminal with built in camera, the user of the mobile terminal can send the image data without carrying out any specific operation therefor if the image data are sent during a recharging operation that the user necessarily carries out daily. Therefore, the burden on the user can be reduced.

If any one of the network printing systems of the present invention comprises the cellular phone communication system or systems that carry out the data communication with the first communication means, the image data can be sent to the network printing system by communication with the mobile terminal with built in camera via the cellular phone communication network if the load on the cellular phone communication network is comparatively light. In this manner, even if the user is located away from the communicable range of the wireless LAN communication equipment and only the cellular phone communication network is available as an infrastructure for sending the image data, the image data can be sent to the network printing system. Since the data communication using the cellular phone communication network is carried out only in the case where the cellular phone communication network is not heavily loaded, the communication time can be comparatively short. Therefore, the communication charge can be prevented from becoming expensive.

According to IMT 2000 as a standard for a next-generation cellular phone, a communication speed thereof is 2 Mbps at most. IMT 2000 is slow if compared to the wireless LAN, and adopts the packet-based charge system. However, image data of 600 KB can be sent in 2.4 seconds, which is not stressful for the user to send the image data, in comparison with the current cellular phone communication network.

By installing the remote area communication system having the remote area image server and the remote are a wireless LAN communication equipment at the remote location, the image data transmitted from the mobile terminal with built in camera are sent from the remote area communication system to the laboratory system or one of the laboratory systems. The mini-laboratory of the laboratory system that received the image data then generates the printed matter from the image data. Therefore, if the user, who lives in Odawara for example, visits a remote theme park such as Tokyo Disneyland, the user can send the image data to the remote area communication system installed in the theme park, and can place the order of printing with the mini-laboratory so that the user can receive the printed matter when he/she returns to Odawara. In this manner, the user can receive the printed matter on the same day she visits the theme park. Therefore, convenience of the network printing system can be improved.

### BRIEF DESCRIPTION OF THE DRAWINGS

FIG. 1 is a block diagram showing the configuration of a network printing system of an embodiment of the present invention;

FIG. 2 is a block diagram showing the configuration of a cellular phone with built in camera;

FIG. 3 is a flow chart showing the procedure carried out at the time of image data transfer;

FIG. 4 is a flow chart showing the procedure carried out at the time of sending image data to a communication spot;

FIG. 5 is a flow chart showing the procedure carried out by a broadband town after reception of image data;

FIG. 6 is a flow chart showing the procedure carried out by a broadband satellite after reception of image data; and

FIG. 7 is a block diagram showing the configuration of a cellular phone with built in camera having second communication means installed in a recording medium.

### DESCRIPTION OF THE PREFERRED EMBODIMENT

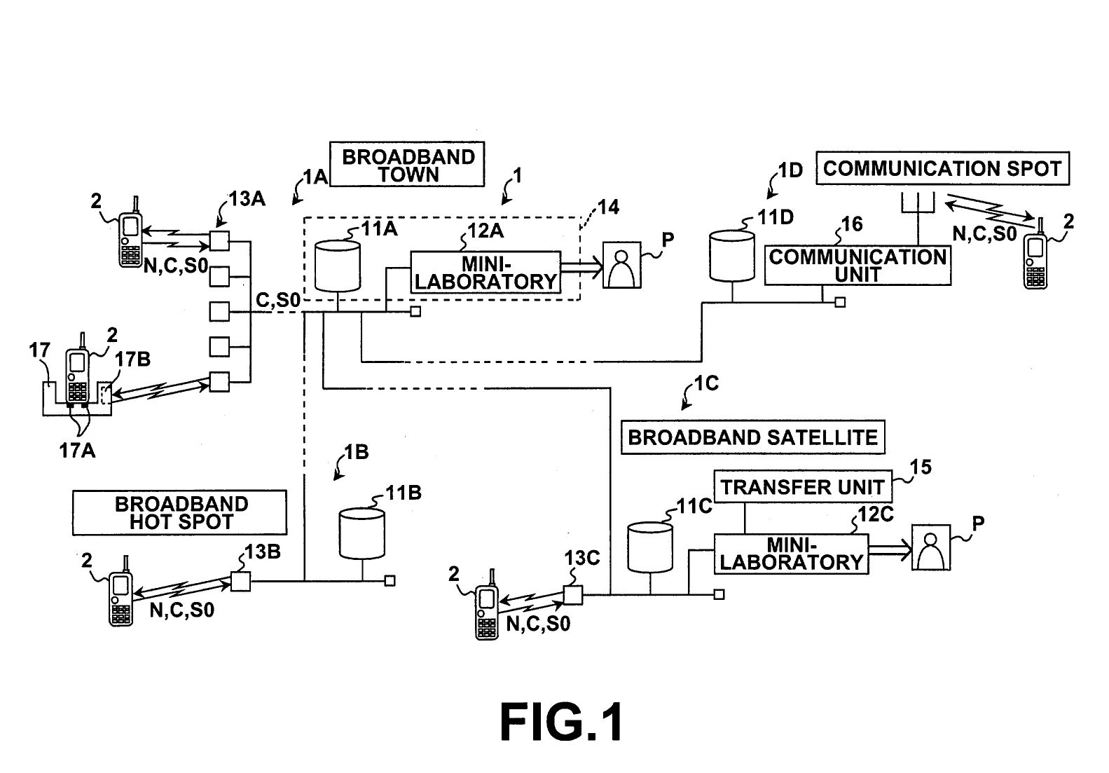

Hereinafter, an embodiment of the present invention will be explained with reference to the accompanying drawings. FIG. 1 is a block diagram showing the configuration of a network printing system of an embodiment of the present invention. As shown in FIG. 1, a network printing system 1 in this embodiment of the present invention provides a printing service regarding an image data set or image data sets S0 (hereinafter referred to as the image data sets S0) obtained by photography with a cellular phone with built in camera 2, a service of recording the image data sets S0 in a CD-R or the like, a service of storing the image data sets S0, and the like.

The network printing system 1 shown in FIG. 1 comprises a broadband town 1A, a broadband hot spot or broadband hot spots 1B (hereinafter referred to as the broadband hot spot 1B), a broadband satellite or broadband satellites 1C (hereinafter referred to as the broadband satellite 1C) and a communication spot or communication spots 1D (hereinafter referred to as the communication spot 1D). The broadband town 1A and the broadband satellite 1C correspond to the laboratory systems described above. The broadband hot spot 1B and the communication spot 1D also correspond to the above-described remote area communication system and the cellular phone communication system, respectively.

The broadband town 1A comprises a large-capacity image server 11A for storing the image data sets S0, a mini-laboratory 12A for generating a print or prints P (hereinafter referred to as the prints P) from the image data sets S0 and for recording the image data sets S0 in a recording medium such as a CD-R, and a plurality of pieces of wireless LAN communication equipment 13A. All the elements in the broadband town 1A are connected by a wired LAN.

The image server 11A and the mini-laboratory 12A are installed in a DPE store 14 that runs the network printing system 1 in an area.

The mini-laboratory 12A generates the prints P by reading the image data sets S0 stored in the image server 11A, based on the content of an order described by order information C sent from the cellular phone with built in camera 2 as will be explained later, and records the image data sets S0 in a recording medium such as a CD-R or a DVD-R. For this reason, the mini-laboratory 12A comprises image processing means for carrying out image processing on the image data sets S0, a printer, and a recording medium drive.

The wireless LAN communication equipment 13A is installed in locations in the area wherein the DPE store that runs the network printing system 1 can provide the services. For example, the wireless LAN communication equipment 13A is installed at a railroad station, a bus stop, a municipal office, a bank, a convenience store, a downtown center, and the like, where residents in the area often visit. The wireless LAN communication equipment 13A may also be installed in an Internet cafe or the like.

As the wireless LAN communication equipment 13A can be used Air station WLA-L11G manufactured by MELCO INC., for example. The wireless LAN communication equipment 13A can communicate between wired LAN and wireless LAN, and is according to the IEEE 802.11b specification. The wireless LAN communication equipment 13A has a communication speed of 11 Mbps on the wireless LAN. Furthermore, since the wireless LAN communication equipment 13A has been Wi-Fi (the standard for Wireless Fidelity) certified, the wireless LAN communication equipment 13A can communicate with various products corresponding to Wi-Fi. In addition, the wireless LAN communication equipment 13A can communicate via the wireless LAN within a range of 50 m in an office wherein the number of obstacles is small, 25 m in an office wherein the number of obstacles is large, and 160 m outside with no obstacles. Moreover, the wireless LAN communication equipment 13A has a roaming function, a user of the cellular phone with built in camera 2 can continue communication while he/she is moving. The wireless LAN communication equipment 13A also has a multiple channel (14 channels) function that enables reduction in a network load, in addition to a MAC address registration function and a security function using WEP.

A MAC address is a physical address specific to each piece of network equipment. The first 3 bytes of a MAC address represent a vendor code and is assigned and managed by the IEEE. The remaining 3 bytes represent a user code and is assigned and managed by each manufacturer of the network equipment as numbers specific thereto. No two MAC addresses are the same. A unique physical address is assigned by the 6-byte data. Since each of the MAC addresses is represented by the 6-byte data, up to 1.7 million pieces of network equipment can theoretically be recognized by Wi-Fi.

For an infrastructure of the wired LAN and wireless LAN, Speed Net provided by Tokyo Electric Company can be used, for example. Speed Net can provide a service of data transfer at almost the same speed as an ADSL with a fixed charge therefor, by using an optical fiber network and radio antennas installed on utility poles of the company. Speed Net enables wireless LAN communication in a range of 50˜300m from each of the radio antennas. In this case, by installing the wireless LAN communication equipment 13A in a place where one of the radio antennas is located, the network printing system 1 can be configured with use of the infrastructure for Speed Net.

A communication service by using a wireless LAN provided by Mobile Internet Services Inc. (MIS) may also be used as the infrastructure for the wired and wireless LAN in this embodiment.

How the wireless LAN communication equipment 13A and the cellular phone with built in camera 2 can communicate with each other will be explained later.

A cradle 17 may also be installed near each of the pieces of the wireless LAN communication equipment 13A, for recharging the cellular phone with built in camera 2 and for sending the image data S0 to the corresponding piece of wireless LAN communication equipment 13A by reading the data from the cellular phone with built in camera 2. The cradle 17 comprises a terminal 17A for recharging the cellular phone with built in camera 2 and for reading the image data sets S0, and communication means 17B for communicating with the wireless LAN communication equipment 13A. The cradle 17 is connected to a 100V power Source in order to recharge the cellular phone with built in camera 2. By using the cradle 17, even if the cellular phone with built in camera 2 does not have communication means for communicating with the wireless LAN communication equipment 13, the image data sets S0 can be sent to the wireless LAN communication equipment from the cellular phone with built in camera 2. Especially, in the case where the cradle 17 is located at the home of the user of the cellular phone 2 and the home is within a communicable range of any one of the pieces of the wireless LAN communication equipment 13A, the image data sets S0 can be securely sent to the wireless LAN communication equipment 13A during a recharging operation that the user necessarily carries out. Since the recharging operation is necessary, if the image data sets S0 are sent during the recharging operation, the user can send the image data sets S0 in the recharging operation that he/she necessarily carries out daily, without carrying out a specific operation for sending the image data sets S0. Therefore, the user can be less burdened.

The broadband hot spot 1B comprises an image server 11B and wireless LAN communication equipment 13B connected to the image server 11B via a wired LAN. The capacity of the image server 11B is smaller than that of the image server 11A used for temporarily storing the image data sets S0. The broadband hot spot 1B is also connected to the broadband town 1A via a wired LAN. The broadband hot spot 1B is installed in a location remote from the area wherein the DPE store that runs the network printing system 1 can provide the services. For example, if the DPE store is located in Odawara, the remote location refers to a theme park such as Tokyo Disneyland or Universal Studios Japan, a sightseeing spot around Japan, downtown in a neighboring city, an airport, a railroad station, or a rest area on a highway, for example.

A plurality of pieces of the wireless LAN communication equipment 13B may be used. Furthermore, the cradle 17 may also be installed near the wireless LAN communication equipment 13B, as in the case of the broadband town 1A.

The broadband satellite 1C comprises an image server 11C, a mini-laboratory 12C, and wireless communication equipment 13C that are all connected via a wired LAN. The capacity of the image server 11C is smaller than that of the image server 11A that temporarily stores the image data sets S0. The mini-laboratory 12C generates the prints P based on the image data sets S0. The broadband satellite 1C is connected to the broadband town 1A via a wired LAN. The broadband satellite 1C is installed in a location away from the area wherein the DPE store 14 that runs the network printing system 1 can provide the services, as in the case of the broadband hot spot 1B.

Since the broadband satellite 1C has the mini-laboratory 12C, the prints P can be generated immediately after reception of the image data sets S0 at the remote location. However, the mini-laboratory 12C is smaller than the mini-laboratory 12A installed in the DPE store 14 in the broadband town 1A. Therefore, the mini-laboratory 12C can only generate a print of L size, for example. For this reason, the mini-laboratory 12C has a transfer unit 15, and the transfer unit 15 judges whether or not the order described by the order information C can be dealt with by the mini-laboratory 12C. The prints P are generated in the mini-laboratory 12C only in the case where the order can be dealt with by the mini-laboratory 12C. In the case where the mini-laboratory 12C cannot deal with the order, the image data sets S0 and the order information C received by the broadband satellite 1C are sent from the transfer unit 15 to the DPE store 14 in the broadband town 1A where the prints P are generated.

In the broadband satellite 1C, a plurality of pieces of the wireless LAN communication equipment 13C may be used. Furthermore, as in the case of the broadband town 1A, the cradle 17 may be installed near the wireless LAN communication equipment 13C.

The communication spot 1D is installed in a base station of a cellular phone communication network. The communication spot 1D comprises a communication unit 16 for carrying out communication via the cellular phone communication network and an image server 11D having capacity that is smaller than that of the image server 11A. The communication unit 16 and the image server 11D are connected via a wired LAN. The communication spot 1D is also connected to the broadband town 1A via a wired LAN.

Since the communication spot 1D is used for communication via the cellular phone communication network, a communicable range thereof is much wider than those for the broadband town 1A, the broadband hot spot 1B, and the broadband satellite 1C.

The communication unit 16 detects a communication load on the cellular phone communication network when the communication with the cellular phone with built in camera 2 starts as will be explained later. In the case where the communication load is smaller than a predetermined threshold value, the communication unit 16 sends a permission to send the image data sets S0 to the cellular phone with built in camera 2. The communication unit 16 then receives the image data sets S0 sent from the cellular phone 2. In the case where the communication load is not smaller than the threshold value, the communication unit 16 sends to the cellular phone with built in camera 2 information representing the fact that the image data transfer is not permitted, since the cost therefor would increase due to a prolonged communication time.

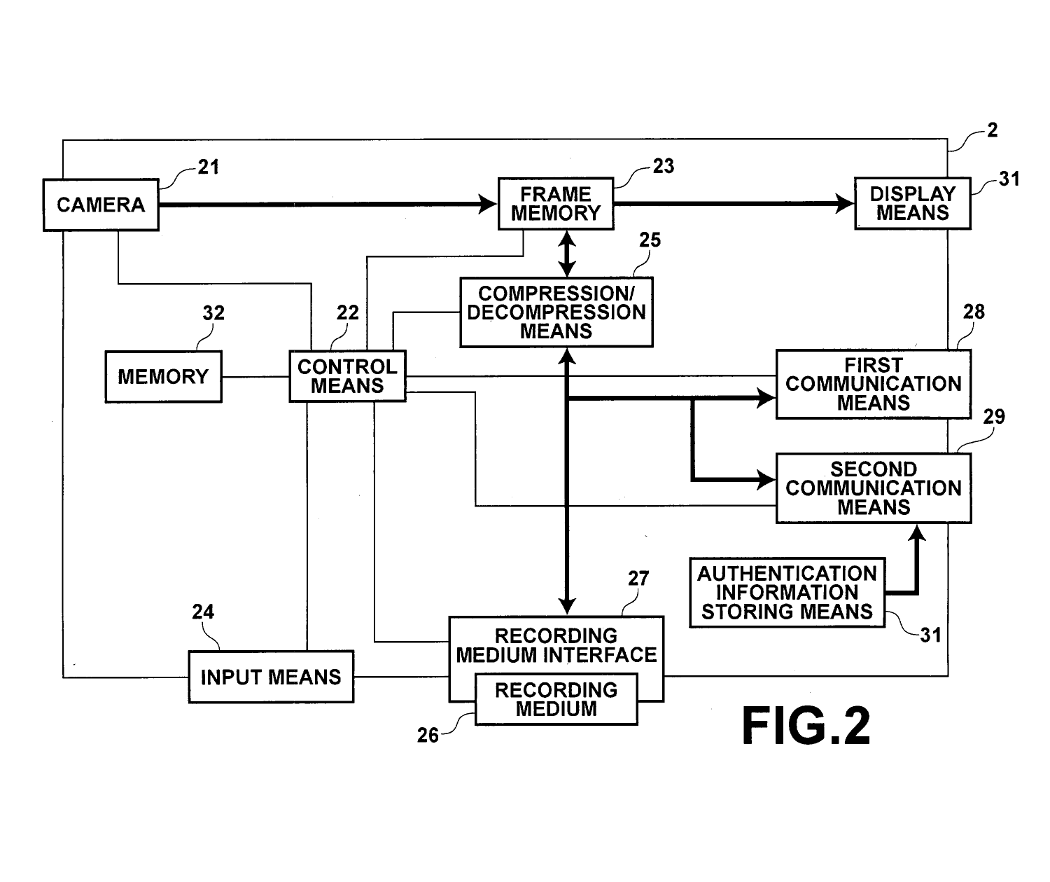

FIG. 2 is a block diagram showing a configuration of the cellular phone with built in camera 2. As shown in FIG. 2, the cellular phone with built in camera 2 comprises a camera 21, control means 22, a frame memory 23, input means 24, compression/decompression means 25, a recording medium interface 27, first communication means 28, second communication means 29, authentication information storing means 30, and display means 31. The camera 21 obtains the image data sets S0 representing images of a subject by photography. The control means 22 controls the entire cellular phone with built in camera 2, carries out control of recording, transmission, and display of the image data sets S0, and generates the order information C describing the content of the order regarding the image data sets S0. The frame memory 23 temporarily stores the image data sets S0. The input means 24 comprises a release button, a communication button, a transmission button, a cruciform key, and number keys for inputting a phone number. The compression/decompression means 25 compresses the image data according to a JPEG format or the like, and decompresses the image data that have been compressed. The recording medium interface 27 carries out data conversion for recording or reading the image data in or from a removable recording medium 26. The first communication means 28 carries out the data communication via the cellular. phone communication network. The second communication means 29 carries out the wireless data communication with the wireless LAN communication equipment 13A, 13B, or 13C (hereinafter referred to as the wireless communication equipment 13A˜13C) in the network printing system 1. The authentication information storing means 30 stores authentication information N that is necessary for communication with the wireless LAN communication equipment 13A˜13C. The authentication information storing means also stores information that is specific to the cellular phone 2. The display means 31 comprises a liquid crystal display monitor or the like for displaying the image data sets S0 and the like.

The recording medium 26 is a removable recording medium such as a memory card or an MO disc that uses a semiconductor, magnetic recording, or optical recording.

The control means 22 is connected to a memory 32 comprising a ROM and a RAM. The ROM stores an execution program or the like and the RAM is a memory used for execution of the program.

The first communication means 28 sends the image data sets S0, receives various kinds of information, and carries out the data communication, via the cellular phone communication network. The communication by the first communication means 28 has a data transfer speed of 9600˜64000 bps, and costs 15˜25 yen per minute in the case of a time-based charge system. In the case of a packet-based charge system, the communication costs 0.2 yen per 128 bytes.

The second communication means 29 is used for the wireless data communication to the wireless LAN communication equipment 13A˜13C in the network printing system 1. The speed of the wireless data communication is more than 8˜11 Mbps. The second communication means 29 adopts the IEEE 802.11b specification as a communication standard therefor, as in the case of the wireless LAN communication equipment 13A˜13C.

The authentication information storing means 30 stores the authentication information N that is necessary for the second communication means 29 to carry out the communication with the wireless LAN communication equipment 13A˜13C. The authentication information storing means also stores the information specific to the cellular phone 2 (hereinafter referred to as the specific information).

An ESS-ID corresponding to the MAC address of the wireless LAN communication equipment 13A˜13C is used as the authentication information N. A WEP key for encryption is set to the authentication information N, and the same WEP key is used for the wireless LAN communication equipment 13A, 13B, and 13C.

The model name of the cellular phone 2 is used as the specific information. The specific information may include a photography condition used at the time of obtaining the image data sets S0 by photography with the camera 21. By sending the model name and the photography condition as the specific information to the network printing system 1 together with the image data sets S0, the image processing can be carried out in the mini-laboratory 12A of the DPE store 14 or the like, according to the model of the cellular phone 2 that generated the image data sets S0 or according to the photography condition.

The user of the cellular phone 2 can select which of the image data sets S0 are sent to the network printing system 1 by displaying the image data sets S0 on the display means 31 after photography. The user can also specify the content of the order regarding the image data sets S0. For example, the image data sets S0 may be stored in the image server 11A, or printed, or recorded in a recording medium such as a CD-R. In the case of printing, a print size, a quantity, and the type of printing (such as generation of postcards or photograph albums) are also described as the content of the order. Once the content of the order has been specified, the order information C describing the content of the order is generated by the control means 22 and recorded in the recording medium 26 via the recording medium interface 27, together with the image data sets S0.

When the user enters the communicable range of any one of the pieces of the wireless LAN communication equipment 13A˜13C (hereinafter referred to as the communicable range of the wireless LAN communication equipment 13A˜13C) so that the second communication means 29 becomes communicable with the wireless LAN communication equipment 13A˜13C, the control means 22 reads the authentication information N from the authentication information storing means 30, and the authentication information N is sent to the wireless LAN communication equipment 13A˜13C via the second communication means 29. The wireless LAN communication equipment 13A˜13C judges whether or not the cellular phone 2 that sent the authentication information N has been registered with the network printing system 1 of the DPE store 14. If a result of this judgment is affirmative and authentication is thus successful, the control means 22 sends to the wireless LAN communication equipment 13A˜13C via the second communication means 29 the image data sets S0 recorded in the recording medium 26, together with the order information C and the specific information.

In the case where the user of the cellular phone with built in camera 2 is not located in the communicable range of the wireless LAN communication equipment 13A˜13C of the broadband town 1A, the broadband hot spot 1B, or the broadband satellite 1C but is located in the communicable range of the communication spot 1D, the user may still wish to send the image data sets S0. In this case, the user tries to send the image data sets S0 by using the first communication means 28.

The communication unit 16 of the communication spot 1D judges the communication load on the cellular phone communication network and permits communication with the cellular phone 2 only in the case where the communication load is smaller than the threshold value, as has been described above. In the cellular phone with built in camera 2, the control means 22 reads the image data sets S0 and the order information C from the recording medium 26, and sends the image data sets S0 and the order information C to the communication spot 1D via the first communication means 28. In the case where the load is heavy and the information representing refusal of communication is received, the control means 22 disconnects the communication between the first communication means 28 and the communication spot 1D.

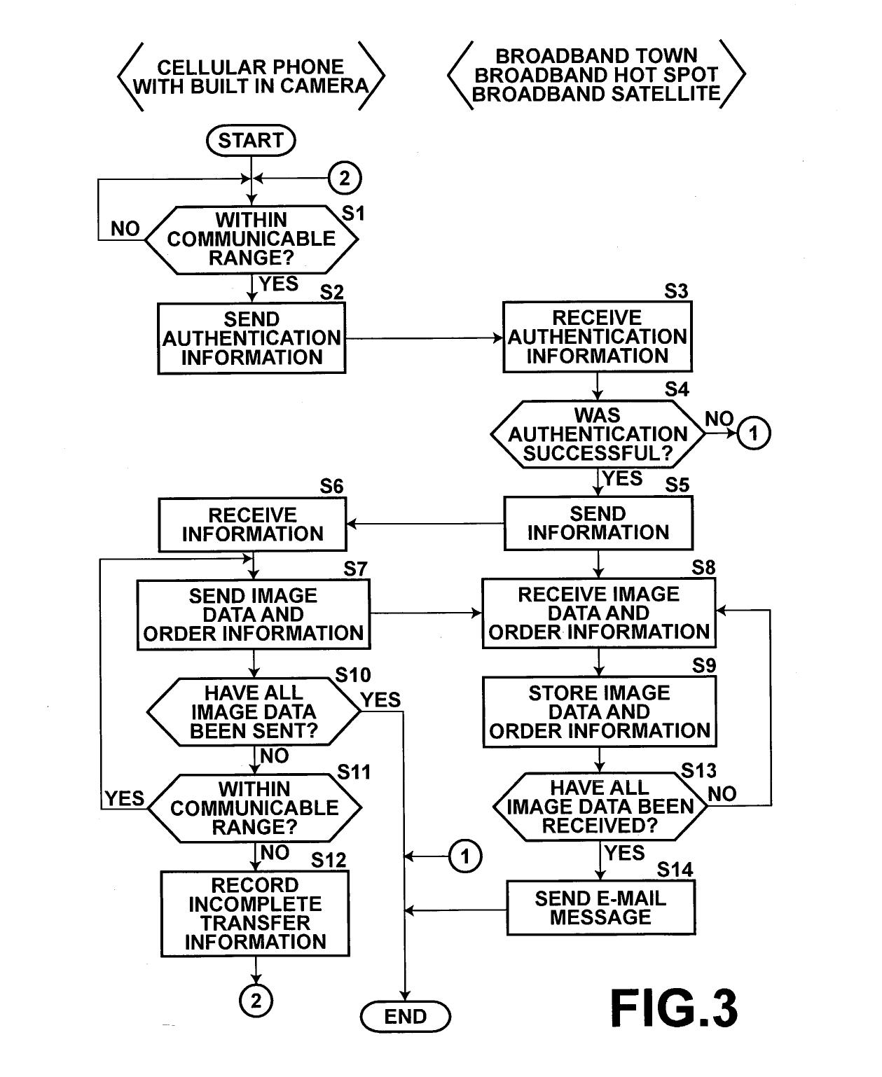

The operation of this embodiment will be explained next. The procedure carried out at the time of transfer of the image data sets S0 from the cellular phone with built in camera 2 will be explained first. FIG. 3 is a flow chart showing the procedure carried out at the time of transfer of the image data sets S0. Since the procedure is the same for sending the image data sets S0 from the cellular phone with built in camera 2 to the broadband town 1A, or to the broadband hot spot 1B, or to the broadband satellite 1C, the case of sending the image data sets S0 from the cellular phone with built in camera 2 to the broadband town 1A will be explained below.

In the explanation below, the cellular phone with built in camera 2 is assumed to have obtained the authentication information N that is necessary for communication with the wireless LAN communication equipment 13A and to have stored the authentication information N in the authentication information storing means 30. The image data sets S0 and the order information C are also assumed to have been generated and recorded in the recording medium 26. Therefore, the image data sets S0 are ready for transfer.

In the cellular phone with built in camera 2, the control means 22 monitors whether or not the second communication means 29 is within the communicable range of any one of the pieces of the wireless LAN communication equipment 13A in the broadband town 1A (Step S1). If a result at Step S1 is affirmative, the control means 22 reads the authentication information N stored in the authentication information storing means 30, and sends the authentication information N to the communicable wireless LAN communication equipment 13A via the second communication means 29 (Step S2).

In the case where the image data sets S0 are sent by setting the cellular phone with built in camera 2 on the cradle 17, the authentication information N stored in the authentication information storing means 30 is read from the terminal 17A, and the communication means 17B sends the authentication information N to the wireless LAN communication equipment 13A corresponding to the cradle 17 when the user sets the cellular phone with built in camera 2 on the cradle 17.

The wireless LAN communication equipment 13A receives the authentication information N (Step S3). In the wireless LAN communication equipment 13A that received the authentication information (hereinafter simply referred to as the wireless LAN communication equipment 13A), it is judged whether or not the cellular phone 2 that sent the authentication information N has been registered with the network printing system 1 of the DPE store 14, that is, whether or not authentication can be made, based on the authentication information N (Step S4). If a result at Step S4 is negative, the data communication is not carried out and the procedure ends. If the result is affirmative, information representing the successful authentication is sent to the cellular phone 2 (Step S5).

The cellular phone with built in camera 2 receives the information (Step S6), and the image data sets S0 and the order information C are read from the recording medium 26 by the control means 22 and sent to the wireless LAN communication equipment 13A (Step S7) in chronological order of photography.

The wireless LAN communication equipment 13A receives the image data sets S0 and the order information C (Step S8), and the image data sets S0 and the order information C are sent to the image server 11A to be stored therein (Step S9).

Meanwhile, in the cellular phone with built in camera 2, a judgment is made as to whether the image data sets S0 recorded in the recording medium 26 have all been sent or not (Step S10). If a result at Step S10 is affirmative, the procedure ends. The image data sets S0 may be deleted from the recording medium 26 in order of transfer. If the result at Step S10 is negative, whether or not the second communication means 29 is within the communicable range of the wireless LAN communication equipment 13A, in consideration of a possibility of the user being on the move (Step S11). If a result at Step S11 is affirmative, the procedure returns to Step S7 and the image data sets S0 are sent continuously. If the result at Step S11 is negative, incomplete transfer information is generated to represent the fact that the image data sets S0 to be sent still exist in the recording medium 26, and recorded in the recording medium 26 (Step S12). The procedure then returns to Step S1.

The user confirms whether or not the incomplete transfer information is recorded in the recording medium 26. In the case where the incomplete information is recorded in the recording medium 26, the user knows that not all the image data sets S0 have been sent. In this case, the user moves to an area where communication with the wireless LAN communication equipment 13A is possible, in order to send the image data sets S0 that have not been sent.

Meanwhile, the wireless LAN communication equipment 13A judges whether all the image data sets S0 have been received or not (Step S13). If a result at Step S13 is affirmative, an E-mail message representing reception completion regarding the image data sets S0 is sent to the cellular phone with built in camera 2 (Step S14) to end the procedure. If the result at Step S13 is negative, the procedure returns to Step S8 and the image data sets S0 are continuously received.

The user of the cellular phone with built in camera 2 knows that the image data sets S0 have securely been sent to the broadband town 1A by viewing the E-mail message.

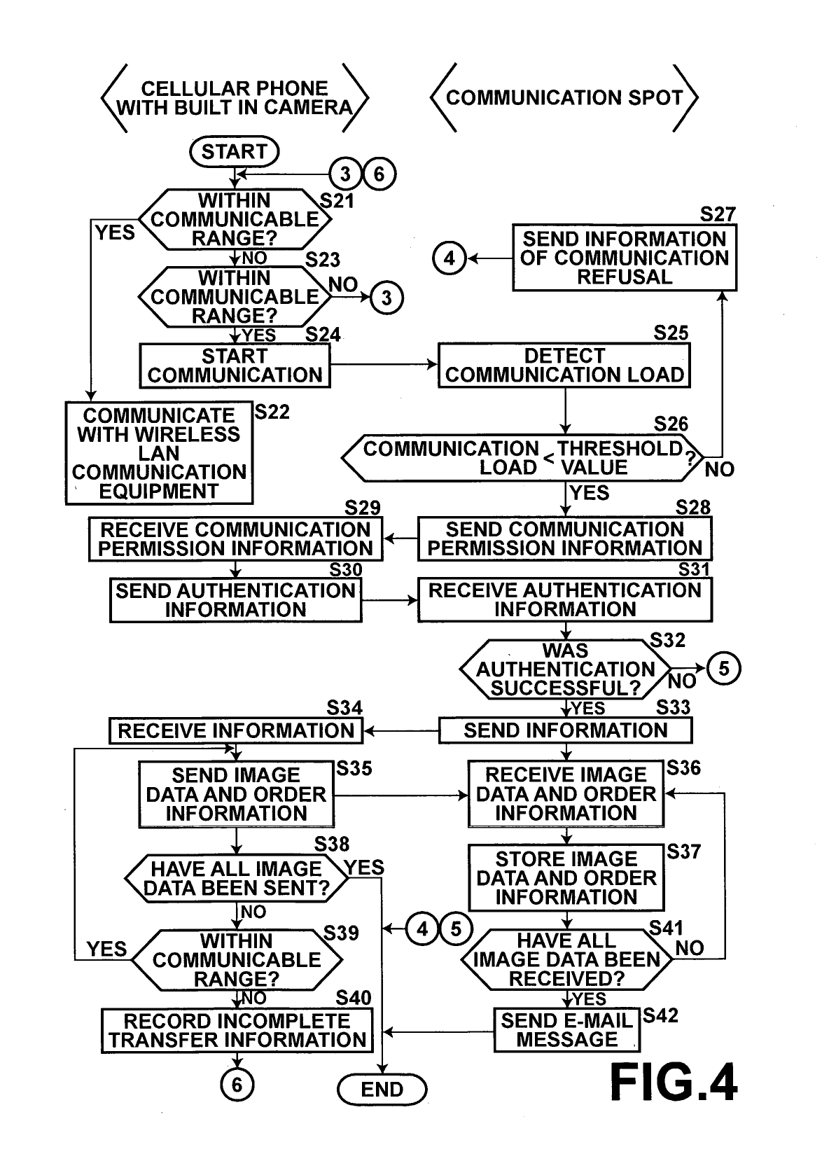

The procedure to be carried out in the case of sending the image data sets S0 to the communication spot 1D will be explained next. FIG. 4 is a flow chart showing the procedure. Whether or not the second communication means 29 is located within the communicable range of the wireless LAN communication equipment 13A˜13C is judged first (Step S21) . If a result at Step S21 is affirmative, the procedure shown in FIG. 3 is carried out by the wireless LAN communication equipment 13A˜13C (Step S22).

If the result at Step S21 is negative, the control means 22 judges whether or not the first communication means 28 is within the communicable range of the cellular phone communication network (Step S23). If a result at Step S23 is affirmative, communication between the first communication means 28 and the communication unit 16 of the communication spot 1D is started via the cellular phone communication network (Step S24). In the case where the first communication means 28 is located outside the communicable range of the cellular phone communication network and the result at Step S23 is thus negative, the procedure returns to Step S21.

The communication unit 16 of the communication spot 1D detects the communication load on the cellular phone communication network (Step S25), and judges whether or not the communication load is smaller than the predetermined threshold value (Step S26) . If a result at Step S26 is negative, the communication network is heavily loaded and transfer of the image data sets S0 takes long. Therefore, the information representing refusal of communication is sent to the cellular phone with built in camera 2 (Step S27) to end the procedure. The information notifying the refusal is sent to the cellular phone with built in camera 2 in the form of an E-mail message or an audio message.

In the cellular phone with built in camera 2, once the information of refusal is received, the control means 22 disconnects the communication between the first communication means 28 and the communication unit 16 via the cellular phone communication network.

If the result at Step S26 is affirmative, the information representing permission of data transfer is sent to the cellular phone with built in camera 2 (Step S28) . In the cellular phone with built in camera 2, the information is received (Step S29), and the control means 22 reads the authentication information N stored in the authentication information storing means 30. The authentication information N is sent to the communication spot 1D via the first communication means 28 (Step S30).

The communication unit 16 of the communication spot 1D receives the authentication information N (Step S31) . The communication unit 16 judges whether or not the cellular phone with built in camera 2 that sent the authentication information N has been registered with the network printing system 1 of the DPE store 14, that is, whether or not authentication can be made, based on the authentication information N (Step S32). If a result at Step S32 is negative, the data communication is not carried out and the procedure ends. If the result is affirmative, information representing the successful authentication is sent to the cellular phone with built in camera 2 (Step S33).

The cellular phone with built in camera 2 receives the information (Step S34), and the control means 22 reads the order information C and the image data sets S0 from the recording medium 26. The order information C and the image data sets S0 are sent to the communication unit 16 (Step S35). The image data sets S0 are sent to the communication unit 16 in chronological order of photography, for example.

The communication unit 16 receives the order information C and the image data sets S0 (Step S36). The order information C and the image data sets S0 are sent to the image server 11D and stored therein (Step S37).

Meanwhile, in the cellular phone with built in camera 2, whether all the image data sets S0 recorded in the recording medium 26 have been sent or not is then judged (Step S38). If a result at Step S38 is affirmative, the procedure ends. The image data sets S0 may be deleted from the recording medium 26 in order of transfer. If the result at Step S38 is negative, whether or not the first communication means 28 is within the communicable range of the cellular phone communication network, in consideration of a possibility of the user on the move (Step S39). If a result at Step S39 is affirmative, the procedure returns to Step S35 to continue transfer of the image data sets S0 that have not been sent yet. If the result at Step S39 is negative, the incomplete transfer information is generated representing the fact that the image data sets S0 whose transfer has not been completed still exist in the recording medium 26. The incomplete transfer information is recorded in the recording medium 26 (Step S40) and the procedure returns to Step S21.

The user of the cellular phone with built in camera 2 confirms whether or not the incomplete transfer information is recorded in the recording medium 26. In the case where the information exists in the recording medium 26, the user knows that not all the image data sets S0 have been transferred. In this case, the user moves to the communicable range of the wireless LAN communication equipment 13A˜13C or the communication unit 16, in order to send the image data sets S0 that have not been sent yet.

The communication unit 16 judges whether all the image data sets S0 have been received or not (Step S41). If a result at Step S41 is affirmative, the E-mail message representing reception completion regarding the image data sets S0 is sent to the cellular phone with built in camera 2 (Step S42) to end the procedure. If the result at Step S41 is negative, the procedure returns to Step S36 to continue reception of the image data sets S0.

The user of the cellular phone with built in camera 2 knows that the image data sets S0 have securely been sent to the communication spot 1D by viewing the E-mail message.

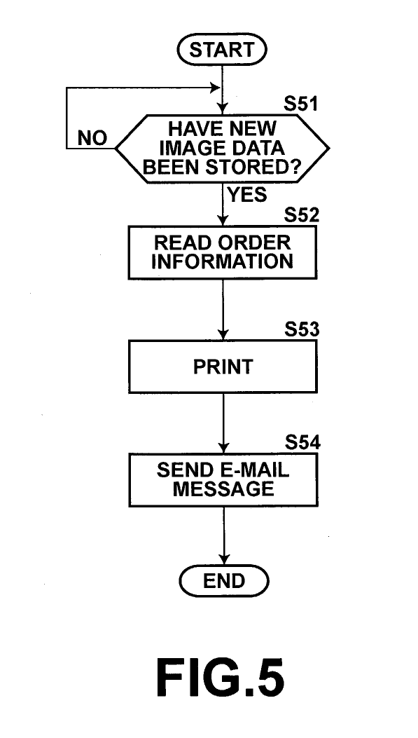

The procedure carried out in the network printing system 1 after reception of the image data sets S0 will be explained below. FIG. 5 is a flow chart showing the procedure carried out by the broadband town 1A after reception of the image data sets S0. In this embodiment, the user of the cellular phone with built in camera 2 has specified printing of the image data sets S0 as the content of the order information C. In the case where the image data sets S0 have been sent to the broadband hot spot 1B or the communication spot 1D, the image data sets S0 are temporarily stored in the image server 11B or 11D therein and transferred to the image server 11A of the broadband town 1A.

The mini-laboratory 12A regularly accesses the image server 11A, and judges whether or not the image data sets S0 have newly been stored in the image server 11A (Step S51). In the case where the image data sets S0 have been stored and a result at Step S51 is thus affirmative, the mini-laboratory 12A reads the order information C received together with the image data sets S0 (Step S52).

The image data sets S0 are read from the image server 11A, and printed after the image processing is carried out thereon, based on the content of the order described in the order information C (Step S53). More specifically, the image data sets S0 are printed according to the size, the quantity, and the type of printing described in the content of the order. After completion of printing, a reception number issued by the DPE store 14 and an E-mail message notifying completion of printing are sent to the user of the cellular phone with built in camera 2 (Step S54) to end the procedure.

The user of the cellular phone with built in camera 2 knows that printing of the image data sets S0 he/she has sent has been completed, by viewing the E-mail message. The user then visits the DPE store 14 to receive the prints P. At this time, the user is authenticated by the reception number sent together with the E-mail message, and the user can receive the prints P. In the case where the prints P are to be delivered to the user according to a contract between the user and the DPE store 14, the prints P are delivered to an address (the address of the user, for example) that has been registered in advance.

The printing charge may be paid directly by the user at the DPE store 14. Alternatively, since the user pays a communication charge to a cellular phone company, the user may pay the printing charge to the cellular phone company so that the printing charge can be paid to the DPE store 14 via the cellular phone company. In this case, since the cellular phone company provides a discount service to the user, the cellular phone company can provide a further discount service via the DPE store 14, such as discounting the communication charge in accordance with the use of the DPE store 14.

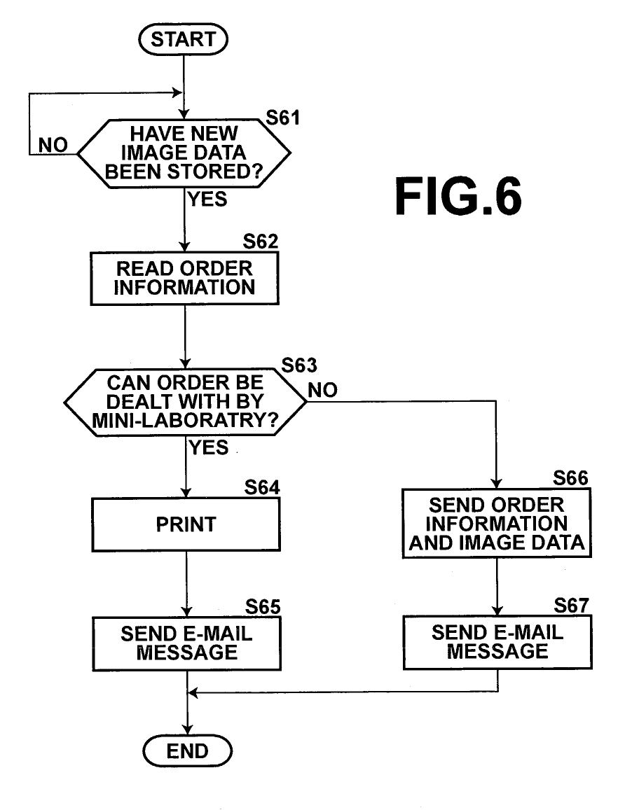

FIG. 6 is a flow chart showing the procedure carried out after the image data sets S0 are received by the broadband satellite 1C. The user is again assumed to have described printing of the image data sets S0 as the content of the order in the order information C.

The mini-laboratory 12C regularly accesses the image server 11C, and judges whether or not the image data sets S0 have newly been stored in the image server 11C (Step S61). In the case where the image data sets S0 have been stored and a result at Step S61 is thus affirmative, the mini-laboratory 12C reads the order information C received together with the image data sets S0 (Step S62).

The transfer unit 15 judges whether or not the content of the order described in the order information C can be dealt with by the mini-laboratory 12C (Step S63) . If a result at Step S63 is affirmative, the image data sets S0 are read from the image server 11C, and printed after the image processing is carried out thereon, based on the content of the order described in the order information C (Step S64). More specifically, the image data sets S0 are printed according to the size, the quantity, and the type of printing described in the content of the order. After completion of printing, a reception number issued by the broadband satellite 1C and an E-mail message notifying completion of printing are sent to the user of the cellular phone with built in camera 2 (Step S65) to end the procedure.

The user of the cellular phone with built in camera 2 knows that printing of the image data sets S0 he/she has sent has been completed, by viewing the E-mail message. The user then visits the broadband satellite 1C to receive the prints P. At this time, the user is authenticated by the reception number sent together with the E-mail message, and the user can receive the prints P. In the case where the prints P are to be delivered to the user according to the contract between the user and the DPE store 14, the prints P are delivered to the address (the address of the user, for example) that has been registered in advance.

Since the broadband satellite 1C is installed in a theme park or the like where the user visits, the user can obtain the prints P immediately at the place.

If the result at Step S63 is negative, the order cannot be dealt with by the mini-laboratory 12C. Therefore, the transfer unit 15 sends the image data sets S0 and the order information C to the image server 11A of the DPE store 14 (Step S66). An E-mail message is sent to the user for notifying the user of the fact that printing is carried out by the DPE store 14 regarding the image data sets S0 sent by the user (Step S67), to end the procedure.

The user knows that printing is carried out by the DPE store 14 by viewing the message.

As has been described above, according to this embodiment, the image data sets S0 are sent to the wireless LAN communication equipment 13A˜13C of the network printing system 1 by the wireless LAN that has much faster speed than the cellular phone communication network. If the speed of the wireless LAN is 11 Mbps, for example, the time necessary for sending the image data sets S0 of 600-KB size is 0.4 second. Therefore, the user can efficiently send the image data sets S0 from the cellular phone with built in camera 2 to the network printing system 1, in order to request storage or printing of the image data sets S0. In many cases, the communication charge for wireless LAN is fixed. Therefore, the user can send the image data sets S0 in a large amount to the network printing system 1 by paying the fixed charge.

Since the DPE store that runs the network printing system 1 can efficiently gather the image data sets S0 without using the cellular phone communication network, sales can be increased.

The image data sets S0 are sent when the user enters the communicable range of the wireless LAN communication equipment 13A˜13C. Therefore, by installing the wireless LAN communication equipment 13A˜13C in many places, transfer of the image data sets S0 can be completed without the user notifying the fact. Therefore, the user does not need to carry out a transfer operation regarding the image data sets S0. In this manner, the user is less burdened at the time of transfer of the image data sets S0.

If the order information C describing the content of the order regarding the image data sets S0 is sent together with the image data sets S0, the user can easily request storage in the image server 11A or printing regarding the image data sets S0.

In the case where the order described in the order information C sent from the cellular phone with built in camera 2 to the broadband satellite 1C cannot be dealt with by the mini-laboratory 12C installed in the broadband satellite 1C, the order information C and the image data sets S0 are transferred to the DPE store 14 that can deal with the order. Therefore, inconvenience caused by incapability of printing the image data sets S0 can be avoided.

By installing the broadband hot spot 1B away from the broadband town 1A, the image data sets S0 sent from the cellular phone with built in camera 2 are transferred to the image server 11A of the DPE store 14 via the broadband hot spot 1B. Therefore, if the user lives in Odawara and visits a remote theme park such as Tokyo Disneyland, the user can send the image data sets S0 to the broadband hot spot 1B installed in the theme park and can generate the order information C so as to receive the prints P when he/she returns to Odawara. In this manner, the user can receive the prints P on the same day he/she visits the theme park. In this manner, convenience of the network printing system 1 can be improved.

If the cellular phone with built in camera 2 communicates with the communication spot 1D and sends the image data sets S0 in the case where the communication load on the cellular phone communication network is not heavy, the image data sets S0 can be sent to the network printing system 1 even in the case where the cellular phone with built in camera 2 cannot carry out wireless communication with the broadband town 1A, the broadband hot spot 1B or the broadband satellite 1C. Since this transfer of the image data sets S0 via the cellular phone communication network is carried out only in the case where the communication load on the cellular phone communication network is not heavy, the time necessary for this communication can be comparatively short. Therefore, the communication charge can be prevented from becoming expensive.

By installing the cradle 17 near each of the pieces of the wireless LAN communication equipment 13A and by sending the image data sets S0 while recharging the cellular phone with built in camera 2, the image data sets S0 can be sent to the network printings system 1 even if the cellular phone 2 does not have the second communication means 29 for communicating with the wireless LAN communication equipment 13A.

By sending the image data sets S0 from the cradle 17 that has the recharging function, the image data sets S0 can be sent during the recharging operation of the cellular phone 2 that is necessarily carried out in use of the cellular phone 2.

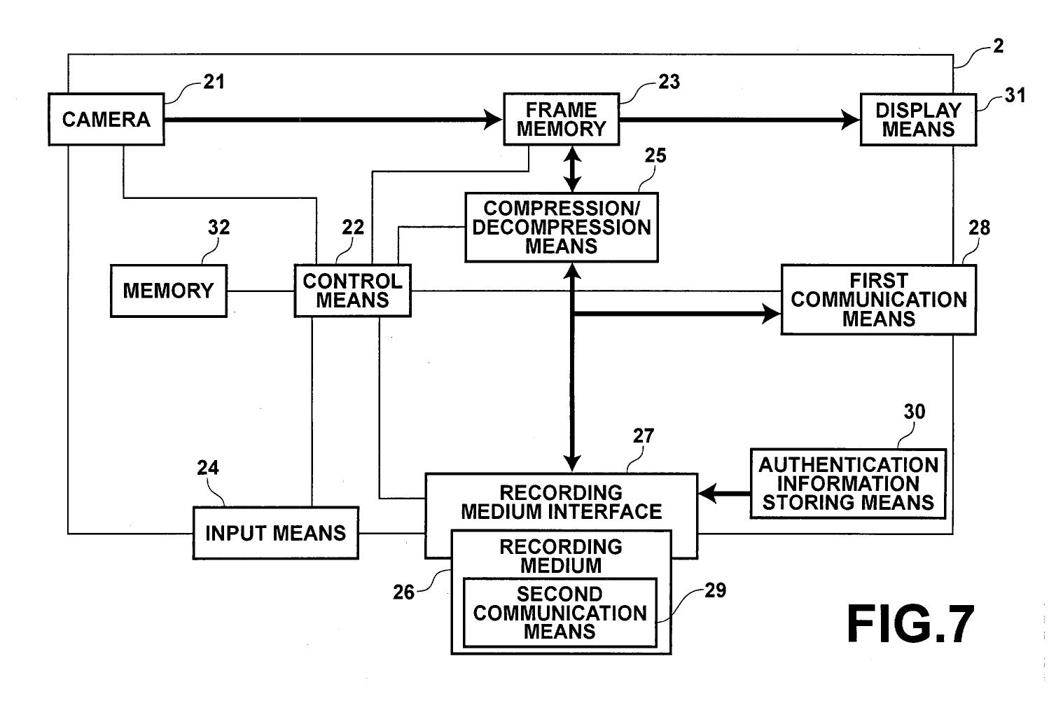

As shown in FIG. 7, the second communication means 29 may be installed in the recording medium 26. In this case, if the DPE store 14 installs in the recording medium 26 the second communication means 29 that can communicate only with the wireless LAN communication equipment 13A˜13C of the network printing system 1 and provides the recording medium 26 having the second communication means 29 therein to the user of the cellular phone with built in camera 2, the image data sets S0 obtained by the user are sent only to the network printing system 1 of the DPE store 14. Therefore, the DPE store 14 can count the user as a customer thereof, and can increase sales.

What is claimed is:

1. A mobile terminal with a built in camera comprising:
photography means for obtaining image data by photography;
first communication means for carrying out data communication via a cellular phone communication network;
second communication means for carrying out data communication with wireless LAN communication equipment via a wireless LAN;
authentication information storing means for storing authentication information that is necessary for carrying out the data communication with the wireless LAN communication equipment via the wireless LAN;
image storing means for storing the image data obtained by the photography means; and
control means for judging whether or not the second communication means is within a communicable range of the wireless LAN communication equipment, for sending to the wireless LAN communication equipment the authentication information stored in the authentication information storing means by carrying out the data communication with the wireless LAN communication equipment in the case where the second communication means has been judged to be within the communicable range, and for controlling the second communication means so that the image data stored in the image storing means are transferred to the wireless LAN communication equipment when authentication according to the authentication information is successfully carried out by the wireless LAN communication equipment.

2. A mobile terminal with a built in camera as defined in claim 1, wherein the image storing means can be detached freely therefrom and the second communication means is installed in the detachable image storing means.

3. A mobile terminal with a built in camera as defined in claim 1, wherein the control means generates order information representing the content of an order regarding the image data and controls the second communication means so that the order information is sent to the wireless LAN communication equipment at the time of transfer of the image data.

4. A network printing system comprising at least one laboratory system having a network for connecting:
at least one piece of the wireless LAN communication equipment for carrying out the data communication with the mobile terminal with a built in camera defined in claim 1 via the wireless LAN;
an image server for storing the image data received by the wireless LAN communication equipment; and
a mini-laboratory for generating printed matter based on the image data stored in the image server.

5. A network printing system comprising at least one laboratory system having a network for connecting:
at least one piece of the wireless LAN communication equipment for carrying out the data communication with the mobile terminal with a built in camera defined in claim 3 via the wireless LAN;
an image server for storing the image data received by the wireless LAN communication equipment; and
a mini-laboratory for generating printed matter based on the image data stored in the image server.

6. A network printing system comprising laboratory systems having a network for connecting:
at least one piece of the wireless LAN communication equipment for carrying out the data communication with the mobile terminal with a built in camera defined in claim 3 via the wireless LAN;
an image server for storing the image data received by the wireless LAN communication equipment; and
a mini-laboratory for generating printed matter based on the image data stored in the image server, wherein
each of the laboratory systems judges whether or not the order described by the order information sent from the mobile terminal with a built in camera can be dealt with by the mini-laboratory therein, generates the printed matter in the mini-laboratory according to the image data in the case where the order can be dealt with, and further comprises transfer means for transferring the image data and the order information to another one of the laboratory systems that can deal with the order in the case where the order cannot be dealt with.

7. A network printing system as defined in claim 4 further comprising, in addition to the laboratory system or systems, at least one cellular phone communication system having:
data communication equipment connected to the laboratory system or systems via the network and for communicating with the first communication means of the mobile terminal with a built in camera defined in claim 1;
communication control means for judging a communication load on the cellular phone communication network and for obtaining the image data by communicating with the mobile terminal with a built in camera in the case where the communication load is comparatively light; and
a temporary storage server for temporarily storing the image data obtained by the communication control means and for sending the image data to the image server of the laboratory system or one of the laboratory systems.

8. A network printing system as defined in claim 5 further comprising, in addition to the laboratory system or systems, at least one cellular phone communication system having:
data communication equipment connected to the laboratory system or systems via the network and for communicating with the first communication means of the mobile terminal with a built in camera defined in claim 1;
communication control means for judging a communication load on the cellular phone communication network and for obtaining the image data by communicating with the mobile terminal with a built in camera in the case where the communication load is comparatively light; and
a temporary storage server for temporarily storing the image data obtained by the communication control means and for sending the image data to the image server of the laboratory system or one of the laboratory systems.

9. A network printing system as defined in claim 6 further comprising, in addition to the laboratory systems, at least one cellular phone communication system having:
data communication equipment connected to the laboratory systems via the network and for communicating with the first communication means of the mobile terminal with a built in camera defined in claim 1;
communication control means for judging a communication load on the cellular phone communication network and for obtaining the image data by communicating with the mobile terminal with a built in camera in the case where the communication load is comparatively light; and
a temporary storage server for temporarily storing the image data obtained by the communication control means and for sending the image data to the image server of one of the laboratory systems.

10. A network printing system comprising at least one laboratory system having a network for connecting:
at least one piece of wireless LAN communication equipment for carrying out data communication via a wireless LAN;
an image server for storing image data received by the wireless LAN communication equipment;
a mini-laboratory for generating printed matter based on the image data stored in the image server; and
at least one reading transmission means for reading the image data from a mobile terminal with a built in camera comprising photography means for obtaining the image data by photography, and for sending the image data to the wireless LAN communication equipment by carrying out the data communication with the wireless LAN communication equipment via the wireless LAN.

11. A network printing system as defined in claim 10, wherein the reading transmission means has a function of recharging the mobile terminal with a built in camera.

12. A network printing system as defined in claim 10 further comprising, in addition to the laboratory system or systems, at least one cellular phone communication system having:
data communication equipment connected to the laboratory system or systems via the network and for communicating with the mobile terminal with a built in camera;
communication control means for judging a communication load on a cellular phone communication network and for obtaining the image data by communicating with the mobile terminal with a built in camera via the cellular phone communication network in the case where the communication load is comparatively light; and
a temporary storage server for temporarily storing the image data obtained by the communication control means and for sending the image data to the image server of the laboratory system or one of the laboratory systems.

13. A network printing system as defined in claim 11 further comprising, in addition to the laboratory system or systems, at least one cellular phone communication system having:
data communication equipment connected to the laboratory system or systems via the network and for communicating with the mobile terminal with a built in camera;
communication control means for judging a communication load on a cellular phone communication network and for obtaining the image data by communicating with the mobile terminal with a built in camera via the cellular phone communication network in the case where the communication load is comparatively light; and
a temporary storage server for temporarily storing the image data obtained by the communication control means and for sending the image data to the image server of the laboratory system or one of the laboratory systems.

14. A network printing system as defined in claim 4 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.

15. A network printing system as defined in claim 5 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.

16. A network printing system as defined in claim 6 further comprising, in addition to the laboratory systems, at least one remote area communication system having:
remote area wireless LAN communication equipment installed in a location remote from the laboratory systems; and
a remote area image server for temporarily storing image data received by the remote area wireless LAN communication equipment and for sending the image data to the image server in one of the laboratory systems.

17. A network printing system as defined in claim 7 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.

18. A network printing system as defined in claim 8 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.

19. A network printing system as defined in claim 9 further comprising, in addition to the laboratory systems, at least one remote area communication system having:
remote area wireless LAN communication equipment installed in a location remote from the laboratory systems; and
a remote area image server for temporarily storing image data received by the remote area wireless LAN communication equipment and for sending the image data to the image server in one of the laboratory systems.

20. A network printing system as defined in claim 10 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.

21. A network printing system as defined in claim 11 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.

22. A network printing system as defined in claim 12 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.

23. A network printing system as defined in claim 13 further comprising, in addition to the laboratory system or systems, at least one remote area communication system having:
remote area wireless LAN communication equipment installed in a location remote from the laboratory system or systems; and
a remote area image server for temporarily storing image data received by the remote area wireless LAN communication equipment and for sending the image data to the image server in the laboratory system or one of the laboratory systems.
